(19) United States
(12) Patent Application Publication
(10) Pub. No.: US 2007/0211850 A1
(43) Pub. Date: Sep. 13, 2007

(54) Cleaning of Multi-Layer Mirrors

(76) Inventors: Richard Michael Lambert, Cambridge (GB); Robert Bruce Grant, West Sussex (GB)

Correspondence Address: THE BOC GROUP, INC., 575 MOUNTAIN AVENUE, MURRAY HILL, NJ, 07974-2064, US

(21) Appl. No.: 11/578,648

(22) PCT Filed: Apr. 11, 2005
(86) PCT No.: PCT/GB05/01375

§ 371 Date: Oct. 13, 2006

(30) Foreign Application Priority Data
Apr. 16, 2004 (GB) 0408543.7

(51) Int. Cl. B08B 7/00; B08B 3/12; G21C 1/00; G21K 5/00

(52) U.S. Cl. 378/34; 134/1; 134/1; 422/159

(57) ABSTRACT

A method of controlling carbonaceous contamination of the surface of a mirror coated with a metal layer comprises the steps of supplying to the mirror a source of carbon for forming carbonaceous deposits on the mirror surface, and a source of a reactant for reacting with the deposits either reductively or by incorporation of hetero-atoms other than oxygen to produce a volatile product, and exposing the mirror to extreme ultra violet (EUV) radiation to activate the reaction. Controlling to the partial pressure ratio of the carbon source and the reactant source can enable the level of contamination of the mirror surface to be actively controlled.

This invention relates to in situ cleaning of multi-layer mirrors. The invention finds particular use in the in situ cleaning of multi-layer mirrors in lithography apparatus.

Photolithography is an important process step in semiconductor device fabrication. In overview, in photolithography a circuit design is transferred to a wafer through a pattern imaged on to a photoresist layer deposited on the wafer surface. The wafer then undergoes various etch and deposition processes before a new design is transferred to the wafer surface. This cyclical process continues, building up the multiple layers of the semiconductor device.

In lithographic processes used in the manufacture of semiconductor devices, it is advantageous to use radiation of very short wavelength, in order to improve optical resolution, so that very small features in the device may be accurately reproduced. In the prior art, monochromatic visible light of various wavelengths have been used, and more recently radiation in the deep ultra violet (DUV) range has been used, including radiation at 248 nm, 193 nm and 157 nm. In order to further improve optical resolution, it has also been proposed to use radiation in the extreme ultra violet (EUV) range, including radiation at 13.5 nm.

The use of EUV radiation for lithography creates many new difficulties, both for the optics in the lithography tool, and also in the EUV radiation source.

One problem is that EUV radiation has poor transmissibility through most gases at atmospheric pressures, and therefore much of the mechanical, electrical and optical equipment involved in the lithography process must be operated in a high-purity vacuum environment. In many cases, gas purge flows are used to prevent contaminating materials (such as photoresist and photoresist by-products) reaching the optical components, and to provide cooling and to prevent migration of particles. Gases may also be used in hydrostatic or hydrodynamic bearings in order to allow mechanical motion of the wafer or the mask.

A further problem is that lens materials used for projection and focussing of radiation in DUV lithography, such as calcium fluoride, are not suitable for transmission of EUV radiation, and it is usually necessary to use reflective optical devices (mirrors) in place of transmissive optical devices (lenses). These mirrors generally have multilayer molybdenum-silicon surfaces, which are extremely sensitive to contamination. In the presence of EUV radiation, secondary electrons are released from the multi-layer mirror (MLM) surface, which interact with contaminants on the surface, reducing their reflectivity. Adsorbed water vapour on the mirror surface causes oxidation of the uppermost silicon layer. Adsorbed hydrocarbon or other carbonaceous deposits can be cracked to form graphitic carbon layers adhering to the surface. The resulting loss of reflectivity leads to reduced illumination and consequent loss of tool productivity. Due to the high cost of these optical components, it is always undesirable to replace them, and in many cases it is completely impractical.

A significant improvement in the oxidation resistance of MLMs has been achieved by “capping” the MLM with ruthenium but this does not mitigate the cracking of residual organic material.

MLMs have been successfully clean ex-situ using glow discharge plasmas of both oxygen and hydrogen. However, such methods are not suitable for a production EUV lithography tool where the MLMs cannot be removed from the system and there is no opportunity for an in-situ plasma discharge due to the complexity of the vacuum system.

The deposition and in-situ removal of carbonaceous layers on MLMs has been studied by many groups. For example, C H Pruett, AIP Conference Proceedings 1988, Vol. 171 pages 167-174) demonstrated that MLM mirrors can be cleaned in situ by the addition of oxygen at low partial pressures while the optics are illuminated. In H Meiling et al, Proceedings of SPIE Vol 4506 (2001) pages 93-104, the deposition rates of carbonaceous films under simulated EUV lithography conditions were measured. It was demonstrated that high molecular weight organic contamination presented the greatest problem to mirror cleanliness, and that the addition of oxygen at levels of approximately 10×10⁻⁶ mbar could reduce or even reverse the rate of carbonaceous film growth. However, in this case surface oxidation of the mirrors becomes a problem. In K Sugisaki et al, Proceedings of the 2nd EUVL Symposium 2003, it was demonstrated that a pinhole will become completely blocked by the build up of carbonaceous deposits on exposure to EUV radiation in the presence of residual organic material. However, with the addition of oxygen to the residual vacuum the pinhole remains open indefinitely. In addition, US 2002/0083409 describes a method for controlling the build up of carbonaceous deposits on the MLM elements by the addition of oxygen to the vacuum surrounding the MLMs.

It is clear that one of the major disadvantages of the above methods is that the risk of permanent damage to the MLM through irreversible surface oxidation is real. From the known surface chemistry of ruthenium it may be deduced that use of oxygen gas, even at ambient temperatures, would lead to eventual oxidation of the ruthenium mirror surface and permanent loss of performance.

In at least its preferred embodiment, the present invention aims to provide a MLM cleaning method which can remove carbonaceous deposits from the surface of the MLM in situ without leading to MLM oxidation.

In accordance with one aspect of the present invention, there is provided a method of controlling carbonaceous contamination of the surface of a mirror coated with a metal layer, the method comprising the steps of: supplying to the mirror a source of carbon for forming carbonaceous deposits on the mirror surface, and a source of a reactant for reacting with the deposits either reductively or by incorporation of hetero-atoms other than oxygen, for example, nitrogen and/or a halogen, to produce a volatile product; and exposing the mirror to extreme ultra violet radiation to activate the reaction.

An advantage of the invention is that the method does not involve any oxidative procedure for controlling the level of carbonaceous contamination. In this sense, the method is entirely benign towards the mirror surface.

Deliberately supplying a carbon source can overwhelm the effects of the background carbon containing impurities inevitably present in the mirror environment. As a result, the removal of adsorbed carbonaceous deposits is immune to, for example, the effects of uncontrolled outgassing events that inevitably occur during operation of a lithography tool incorporating the mirror. An additional benefit of this approach is that it involves high rates of turnover of the carbonaceous species, thus maintaining the latter in a more reactive, easily removed chemical state. When this is not the case, as in the present state of the art, aging of the carbonaceous deposits leads to its graphitisation, resulting in an optically deleterious and very stable surface coating that cannot be removed.

In this invention, the energy source that drives the reaction to form a volatile product which desorbs from the mirror surface is not thermal energy (heat) but excitation of adsorbed species by processes initiated by the incident EUV radiation. It is highly likely that the decomposition reactions are initiated by low energy photoelectrons (˜50 eV) exiting the mirror surface through the adsorbed layer. However, some direct contribution from photon-stimulated reactions is also possible.

In a preferred embodiment, the partial pressure ratio of the carbon source and the reactant source is controlled to control actively the thickness of the carbonaceous deposits on the mirror surface. By adjusting the partial pressure ratio of the reactive chemical agent and the carbon source, the steady state coverage of carbonaceous deposits can be regulated at a minimal and acceptable level. Thus, the present invention also provides a method of controlling carbonaceous contamination of the surface of a mirror coated with a metal layer, the method comprising the steps of: supplying to the mirror a source of carbon for forming carbonaceous deposits on the mirror surface, and a source of a reactant for reacting with the deposits to produce a volatile product; exposing the mirror to extreme ultra violet radiation to activate the reaction; and controlling the partial pressure ratio of the carbon source and the reactant source to control actively the thickness of the carbonaceous deposits on the mirror surface.

The choice of both carbon source and the chemical agent is determined by a number of criteria, including the probability of dissociative chemisorption on the mirror surface, adequate cross-section for activation by secondary electrons, stability against polymerisation on, for example, the internal surfaces of the lithography tool, gas phase adsorption cross-section to EUV radiation, the compatibility with the tool's vacuum system and its components, and appropriate vacuum pumping speeds.

The preferred reactant sources include molecules, which, when adsorbed, release reactive species to the mirror surface at ambient temperature, either directly, or under the influence of electron impact, the latter produced by photoemission from the mirror itself. The reactive species undergo electron impact activated reactions with the carbonaceous deposits, yielding volatile products that desorb, thus cleaning the mirror surface. Desorption of the volatile products may itself be an electron or photon activated process.

Optionally, a buffer gas can be supplied to maintain a constant pressure in the vicinity of the mirror. The maximum allowable total pressure of the mixture of buffer gas, carbon source and reactant source depends on the absorption cross-section for EUV radiation of the gaseous species and will typically be less than 0.1 mbar.

The present invention extends to a method of in situ cleaning a multi-layer mirror of a lithography tool, comprising a method as aforementioned for removing carbonaceous deposits from the surface of the mirror.

In another aspect, the present invention provides apparatus for controlling carbonaceous contamination of the surface of a mirror coated with a metallic layer, the apparatus comprising means for supplying to the mirror a source of carbon for forming carbonaceous deposits on the mirror surface; means for supplying to the mirror a source of a reactant for reacting with the deposits either reductively or by incorporation of hetero-atoms other than oxygen to produce a volatile product; and means for exposing the mirror to extreme ultra violet radiation to activate the reaction.

Preferably, means are provided for controlling the partial pressure ratio of the carbon source and the reactant source to control actively the thickness of the carbonaceous deposits on the mirror surface. Thus, the present invention also provides apparatus for controlling carbonaceous contamination of the surface of a mirror coated with a metallic layer, the apparatus comprising means for supplying to the mirror a source of carbon for forming carbonaceous deposits on the mirror surface; means for supplying to the mirror a source of a reactant for reacting with the deposits to produce a volatile product; means for exposing the mirror to extreme ultra violet radiation to activate the reaction; and means for controlling the partial pressure ratio of the carbon source and the reactant source to control actively the thickness of the carbonaceous deposits on the mirror surface.

The invention also extends to lithography apparatus comprising a lithography tool housed in a chamber, the tool comprising a mirror coated with a metal layer, and apparatus as aforementioned for removing carbonaceous deposits from the surface of the mirror.

Features described above in relation to method aspects of the invention are equally applicable to apparatus aspects, and vice versa.

By way of example, an embodiment of the invention will now be further described with reference to the following Figures in which:

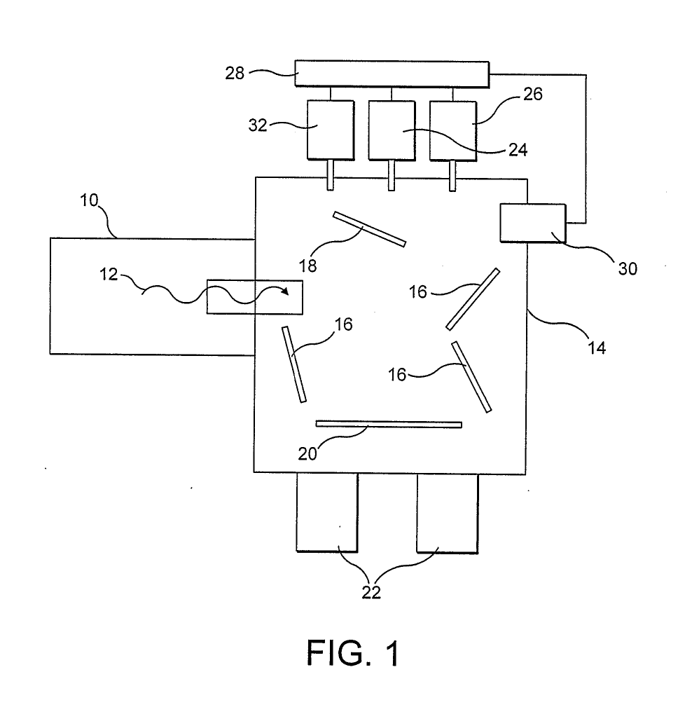

FIG. 1 illustrates schematically an example of an EUV lithography (EUVL) apparatus;

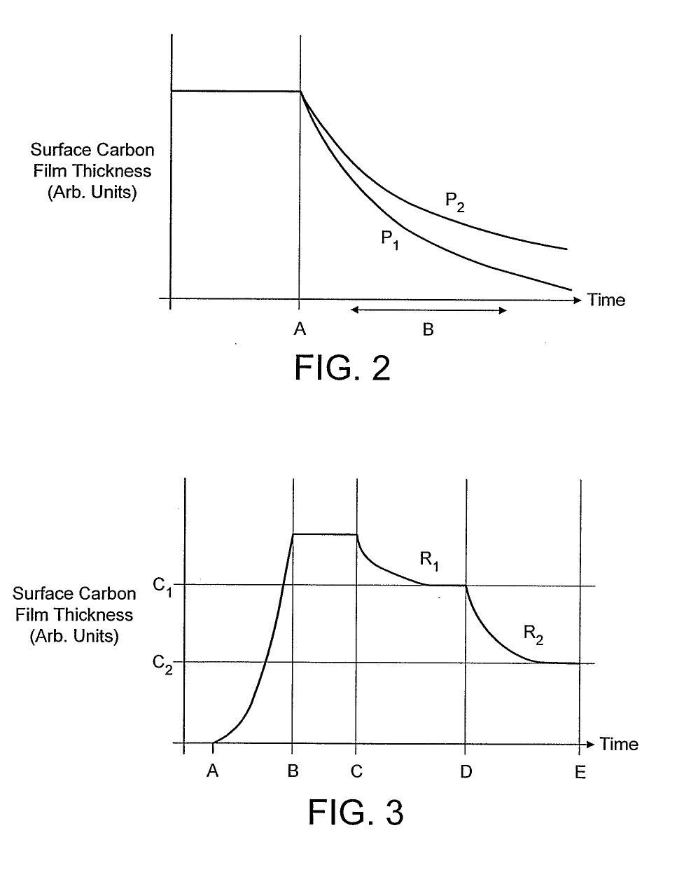

FIG. 2 is a graph illustrating the variation of the rate of decrease of the thickness of a carbonaceous film on a mirror surface with the partial pressure of a reactive agent;

FIG. 3 is a graph illustrating the variation of the thickness of a carbonaceous film on a mirror surface with time during one example of a method of controlling the level of carbonaceous contamination; and

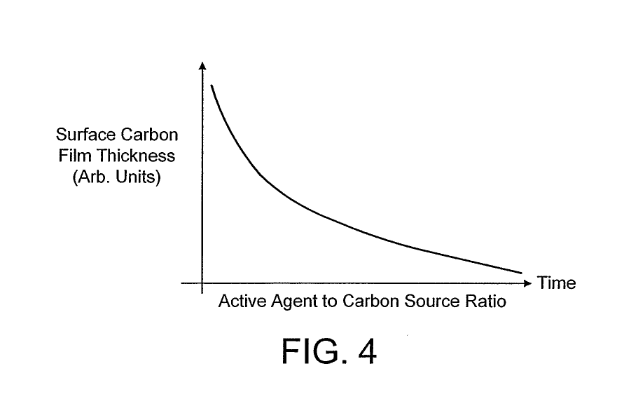

FIG. 4 is a graph indicating the variation of the equilibrium level of carbonaceous contamination with the partial pressure ratio of the carbon source and reactant source.

With reference first to FIG. 1, the EUVL apparatus comprises a chamber 10 containing a source (not shown) of EUV radiation. The source may be a discharge plasma source or a laser-produced plasma source. In a discharge plasma source, a discharge is created in a medium between two electrodes, and a plasma created from the discharge emits EUV radiation. In a laser-produced plasma source, a target is converted to a plasma by an intense laser beam focused on the target. A suitable medium for a discharge plasma source and for a target for a laser-produced plasma source is xenon, as xenon plasma radiates EUV radiation at a wavelength of 13.5 nm.

EUV radiation, indicated at 12, generated in chamber 10 is supplied to another chamber 14 optically linked or connected to chamber 10 via, for example, one or more windows formed in the walls of the chambers 10, 14. The chamber 14 houses a lithography tool, which comprises an optical system of multi-layer mirrors (MLMs) 16 which generate a EUV radiation beam for projection on to a mask or reticle 18 for the selective illumination of a photoresist on the surface of a substrate, such as a semiconductor wafer 20. The MLMs 16 comprise a plurality of layers, each layer comprising, from the bottom a first layer of molybdenum and a second layer of silicon. A metallic layer, preferably formed from ruthenium, is formed on the upper surface of each MLM to improve the oxidation resistance of the MLMs whilst transmitting substantially all of the EUV radiation incident thereon.

Due to the poor transmissibility of EUV radiation through most gases, a vacuum pumping system 22 is provided for generating a vacuum within chamber 14. In view of the complex variety of gases and contaminants, such as water vapour and hydrocarbons, which may be present in chamber 14, the pumping system for chamber 14 may include both a cryogenic vacuum pump and a transfer pump, such as a turbomolecular pump, backed by a roughing pump. Such a combination of pumps can enable a high vacuum to be created in the chamber 14.

As mentioned earlier, in the presence of EUV radiation, secondary electrons are released from within the surfaces of the MLMs, which electrons interact with contaminants on the surfaces, reducing their reflectivity. Cracking of adsorbed hydrocarbon contaminants can form graphitic type carbon layers adhering to the MLMs, with the resulting loss of reflectivity leading to reduced illumination and consequent loss of tool productivity.

In order to control the level of adsorbed hydrocarbon or other carbonaceous deposits on the MLMs, the EUVL apparatus includes a source 24 of a chemical agent which, when adsorbed on the MLM surfaces, releases reactive species to the MLM surfaces, either directly, or under the influence of impact from secondary electrons emitted from within the surface in the presence of EUV radiation. The reactive species undergo electron impact activated reactions with the carbonaceous deposits, yielding volatile products that desorb, thus cleaning the MLM surfaces.

The chemical agents may be either inorganic or organic molecules. Preferred inorganic molecules include hydrogen, ammonia, hydrazine. Preferred organic molecules include amines, pyrrole and its derivatives, pyridine and its derivatives, halogen containing compounds including aryl halides and alkyl halides, both saturated and unsaturated. Thus, the chemical agents react with the carbonaceous deposits either reductively or by the introduction of hetero atoms other than oxygen, for example nitrogen or a halogen, thereby avoiding any oxidation of the MLM surfaces.

FIG. 2 shows the effect of the addition of at least one chemical active agent, for example hydrogen, on the thickness of carbonaceous deposits on an MLM surface under EUV radiation or a flux of low energy electrons initiated at time A. As illustrated, the deposit thickness decreases with time during the period B; the rate of decease is proportional to the partial pressure P of the active agent(s), with P₁>P₂. The maximum allowable total pressure depends on the absorption cross-section for EUV radiation of the active agent(s) and will typically be less than 0.1 mbar.

In order to accommodate for intermittent ‘spikes’ in the hydrocarbon partial pressure background associated with, for example, the activation of vacuum based actuators or the solvent and photoresist outgassing from the introduction of a wafer for processing, a carbon source for the controlled deposition of carbonaceous deposits on the MLM surfaces under EUV radiation is introduced from source 26 together with the chemical agent 24. Deliberately supplying a carbon source can overwhelm the effects of the background carbon containing impurities inevitably present in the chamber 14.

The carbon source is preferably selected from the group comprising carbon monoxide, alkynes, alkenes, aryl oxygenates, aromatics, nitrogen-containing species and halogen-containing species. Examples of suitable oxygenates are alcohols, esters and ethers. Examples of suitable nitrogen-containing compounds are amines, pyrrole and its derivatives, and pyridine and its derivatives. Examples of suitable halogen-containing compounds are saturated aryl hydrides, unsaturated aryl hydrides, saturated alkyl hydrides, and unsaturated alkyl hydrides.

FIG. 3 shows the combined effect of the addition of a carbon source, for example acetylene, together with a chemical active agent, for example, hydrogen. In time period AB only the carbon source is present and the deposit thickness increases as a function of the exposure time until B, where the carbon source is removed and replaced at C with a mixture of active agent and carbon source in the ratio R₁. With reference to FIG. 1, gas inlet controller 28 maintains a constant ratio of the gas flows from the sources 24, 26, and with feedback from a total pressure gauge 30 can maintain a constant total pressure within the chamber 14.

Returning to FIG. 3, with a mixture of active agent and carbon source present within the chamber 14, the surface carbon film thickness subsequently decreases over the time period CD, due to the reductive reaction of the reactive species released from the active agent with the carbonaceous deposits. An equilibrium is eventually reached between carbonaceous deposition and removal of the carbonaceous deposits, after which the deposit thickness remains substantially constant at amount C₁.

At D, the ratio of active agent to carbon source is changed to R₂ so as to increase the relative amount of active agent in the mixture i.e. R₂>R₁. With reference to FIG. 1, the EUV apparatus includes an optional buffer gas source 32 to enable the combined total pressure of the carbon source and chemical active agent to be varied whilst maintaining a constant total pressure within the chamber 14.

With the increased ratio of active agent to carbon source, the equilibrium deposit thickness decreases to a new fixed equilibrium amount C₂ where C₁>C₂. The resulting equilibrium deposit thickness is dependant on the ratio of the partial pressures of the active agent to carbon source as shown in FIG. 4. The time taken to reach the equilibrium deposit thickness is proportional to the partial pressures of the gas phase species, the maximum allowable total pressure of the gas mixture depending on the absorption cross-section for EUV radiation of the gas phase species and will typically be less than 0.1 mbar.

Some examples of reactions occurring within the chamber 14 will now be described.

### EXAMPLE 1

In this example, the chemical active agent is hydrogen, and the carbon source has the general formula CₓH_{y}. Under EUV radiation, the hydrogen and carbon source both dissociate:
H₂(g)→2H(a) (1)
CₓH_{y}+e⁻→CₓH_{y-1}+H(a)+e⁻→CₓH_{y-2}+H(a)+e⁻→→xC+yH(a) (2)
with deposition (adsorption) of x amount of C on the surface of the MLMs. The reactions which then occur within the chamber 14, again under EUV radiation, are:
H(a)+H(a)→H₂(g) (3)
hν+surface→e⁻(photoelectron) (4)
xC+H(a)+e⁻→CₓH(a)+H(a)+e⁻→→→CₓH_{y-1}(a)+H(a)+e⁻→CₓH_{y}(g) (5)
which result in the desorption of the volatile product CₓH_{y} from the surface of the MLMs.

### EXAMPLE 2

This example is similar to Example 1, except that the chemical active agent is ammonia, which decomposes to release active hydrogen species as set out below:
NH₃(g)→NH₂(a)+H(a)
NH₂(a)→NH(a)+H(a)
NH(a)→N(a)+H(a)
with the active nitrogen species subsequently combining to form nitrogen gas:
N(a)+N(a)→N₂(g)
In addition to the reaction of equation (5), the active species NH₂(a) may also react with the CₓH_{y-1} deposits to form the volatile product CₓH_{y-1}NH₂ which desorbs from the MLM surfaces:
CₓH_{y-1}+NH₂(a)+e⁻→CₓH_{y-1}NH₂(g)

### EXAMPLE 3

This example is similar to Example 1, except that the chemical active agent is CH₃NH₂, which decomposes to release active hydrogen species as set out below:
CH₃NH₂(g)→CH₃NH(a)+H(a)
CH₃NH(a)→CH₃N(a)+H(a)
CH₃N(a)+e⁻→HCN(g)+2H(a)

### EXAMPLE 4

In this example, the chemical active agent is CH₂Cl.CH₂Cl, which decomposes to form active chlorine species as set out below
CH₂Cl.CH₂Cl→CH₂ClCH₂(a)+Cl(a)
CH₂ClCH₂(a)+e⁻→CH₂═CH₂(g)+Cl(a)
In this example, equation (5) above is replaced by the following:
Cl(a)+CₓH_{y-1}+e⁻→CₓH_{y-1}Cl(g) (6)
which results in the desorption of the volatile product CₓH_{y-1}Cl from the surface of the MLMs.

1. A method of controlling carbonaceous contamination of the surface of a mirror coated with a metal layer, the method comprising the steps of: supplying to the mirror a source of carbon for forming carbonaceous deposits on the mirror surface, and a source of a reactant for reacting with the deposits either reductively or by incorporation of hetero-atoms other than oxygen to produce a volatile product; and exposing the mirror to extreme ultra violet radiation to activate the reaction.

2. The method according to claim 1, wherein the partial pressure ratio of the carbon source and the reactant source is controlled to control actively the thickness of the carbonaceous deposits on the mirror surface.

3. The method according to claim 2, wherein the partial pressure ratio of the carbon source and the reactant source is controlled to maintain the thickness of the carbonaceous deposits on the mirror surface at or below a predetermined amount.

4. The method according to claim 1, wherein the carbon source is selected from the group comprising carbon monoxide, alkynes, alkenes, aryl oxygenates, aromatics, nitrogen-containing species and halogen-containing species.

5. The method according to claim 4, wherein the oxygenates comprise alcohols, esters and ethers.

6. The method according to claim 5, wherein the nitrogen-containing compounds comprise amines, pyrrole and its derivatives, and pyridine and its derivatives.

7. The method according to claim 6, wherein the halogen-containing compounds comprise saturated aryl hydrides, unsaturated aryl hydrides, saturated alkyl hydrides, and unsaturated alkyl hydrides.

8. The method according to claim 1, wherein the reactant source is selected from the group comprising inorganic molecules and organic molecules.

9. The method according to claim 8, wherein the inorganic molecules comprise hydrogen, ammonia, and hydrazine.

10. The method according to claim 9, wherein the organic molecules comprise amines, pyrrole and its derivatives, pyridine and its derivatives, and halogen-containing compounds.

11. The method according to claim 10, wherein the halogen-containing compounds comprise saturated aryl hydrides, unsaturated aryl hydrides, saturated alkyl hydrides, and unsaturated alkyl hydrides.

12. The method according to claim 1, wherein a buffer gas is supplied to maintain a constant pressure in the vicinity of the mirror.

13. The method according to claim 12, wherein the pressure is less than 1 mbar, preferably less than 0.1 mbar.

14. The method according to claim 1, wherein the mirror comprises a multi-layer mirror.

15. The method according to claim 14, wherein the mirror comprises a plurality of layers, each layer comprising a first layer of molybdenum and a second layer of silicon.

16. The method according to claim 15, wherein the metallic layer is formed from ruthenium.

17. A method of controlling carbonaceous contamination of the surface of a mirror coated with a metal layer, the method comprising the steps of: supplying to the mirror a source of carbon for forming carbonaceous deposits on the mirror surface, and a source of a reactant for reacting with the deposits to produce a volatile product; exposing the mirror to extreme ultra violet radiation to activate the reaction; and controlling the partial pressure ratio of the carbon source and the reactant source to control actively the thickness of the carbonaceous deposits on the mirror surface.

18. The method according to claim 17, wherein the reactant is chosen to react with the deposits either reductively or by incorporation of hetero-atoms other than oxygen to produce the volatile product.

19. A method of in situ cleaning a multi-layer mirror of a lithography tool, comprising supplying to the mirror a source of carbon for forming carbonaceous deposits on the mirror surface, and a source of a reactant for reacting with the deposits either reductively or by incorporation of hetero-atoms other than oxygen to produce a volatile product; and exposing the mirror to extreme ultra violet radiation to activate the reaction.

20. An apparatus for controlling carbonaceous contamination of the surface of a mirror coated with a metallic layer, the apparatus comprising means for supplying to the mirror a source of carbon for forming carbonaceous deposits on the mirror surface; means for supplying to the mirror a source of a reactant for reacting with the deposits either reductively or by incorporation of hetero-atoms other than oxygen to produce a volatile product; and means for exposing the mirror to extreme ultra violet radiation to activate the reaction.

21. The apparatus according to claim 20, comprising means for controlling the partial pressure ratio of the carbon source and the reactant source to control actively the thickness of the carbonaceous deposits on the mirror surface.

22. The apparatus according to claim 20, comprising means for supplying a buffer gas to maintain a constant pressure in the vicinity of the mirror.

23. An apparatus for controlling carbonaceous contamination of the surface of a mirror coated with a metallic layer, the apparatus comprising means for supplying to the mirror a source of carbon for forming carbonaceous deposits on the mirror surface; means for supplying to the mirror a source of a reactant for reacting with the deposits to produce a volatile product; means for exposing the mirror to extreme ultra violet radiation to activate the reaction; and means for controlling the partial pressure ratio of the carbon source and the reactant source to control actively the thickness of the carbonaceous deposits on the mirror surface.

24. A lithography apparatus comprising a lithography tool housed in a chamber, the tool comprising a multi-layer mirror, and the apparatus further comprising means for supplying to the mirror a source of carbon for forming carbonaceous deposits on the mirror surface; means for supplying to the mirror a source of a reactant for reacting with the deposits either reductively or by incorporation of hetero-atoms other than oxygen to produce a volatile product; and means for exposing the mirror to extreme ultra violet radiation to activate the reaction.

25. A method of in situ cleaning a multi-layer mirror of a lithography tool, comprising supplying to the mirror a source of carbon for forming carbonaceous deposits on the mirror surface, and a source of a reactant for reacting with the deposits to produce a volatile product; exposing the mirror to extreme ultra violet radiation to activate the reaction; and controlling the partial pressure ratio of the carbon source and the reactant source to control actively the thickness of the carbonaceous deposits on the mirror surface.

26. A lithography apparatus comprising a lithography tool housed in a chamber, the tool comprising a multi-layer mirror, and the apparatus further comprising means for supplying to the mirror a source of carbon for forming carbonaceous deposits on the mirror surface; means for supplying to the mirror a source of a reactant for reacting with the deposits to produce a volatile product; means for exposing the mirror to extreme ultra violet radiation to activate the reaction; and means for controlling the partial pressure ratio of the carbon source and the reactant source to control actively the thickness of the carbonaceous deposits on the mirror surface.
